(19) United States
(12) Patent Application Publication
(10) Pub. No.: US 2005/0028385 A1
(43) Pub. Date: Feb. 10, 2005

(54) Letter opener

(76) Inventor: Jun Zheng, Canton, MI (US)

Correspondence Address: Jun Zheng, 6294 Woodland Drive, Canton, MI, 48187, US

(21) Appl. No.: 10/636,451

(22) Filed: Aug. 7, 2003

(51) Int. Cl. B26B 29/00

(52) U.S. Cl. 30/294

(57) ABSTRACT

A letter opener (100). Letter opener (100) comprises a main body (102) having an open side, a covering piece (104) for closing up the open side of main body (102), a cutting blade (106), made of a ceramic material, rotatably installed inside main body (102), a spring member (108) installed inside main body (102) for maintaining blade (106) in position and for countering the rotation motion of blade (106) when blade (106) is in cutting mode. On the upper portion of main body (102), there is provided a lip piece (110) having a lower straight surface extending laterally. A through guide groove (112) is formed in between lip (110) and the upper surface of covering piece (104). Blade (106) extends upward across substantially groove (112) at a substantially right angle. When letter opener (100) is sliding along a marginal edge of a letter, cutting blade (106) operates to pierce through one layer of the letter and to cut a cutting line thereon, which is generally parallel to and offset by a slight spacing from the edge of the letter. Letter opener (100) is convenient and safe to use and is of durable construction.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention generally relates to letter openers. More specifically, this invention relates to safety letter openers having a ceramic cutting blade.

### BACKGROUND OF THE INVENTION—PRIOR ART

Letter openers for cutting open envelopes are well known. Typically, a known letter opener includes a generally planar handle portion with a depending integrally molded tine portion. The tine portion is positioned beneath the handle portion so as to create a gap therebetween. A cutting edge, usually of a metal material, is disposed in an inclined position on the neck portion, which is formed between the handle portion and the tine portion. In operation, the tine portion is manually inserted underneath an envelope flap and the letter opener is then forced in a smooth motion against a longitudinal edge of the envelope to cut therethrough.

Although generally acceptable for their intended purpose, such letter openers, despite their widespread use, are not altogether satisfactory.

First, the existence of the spiking point and the openly mounted cutting edge represent potential safety hazards.

Second, it is sometimes difficult to force the pointed end of the tine portion underneath a letter flap, particularly when aggressive adhesives and/or plastic tape are used to seal the flap.

Third, in many cases, a smooth cutting line along the longitudinal edge is not readily achieved, and this results in the envelope being torn apart along an irregular line and, in some cases, completely damaged.

In an attempt to overcome these drawbacks of prior art products, some automatic motor-driven letter openers have been proposed. These letter openers generally have a clearance slot in which an envelope is inserted and along which the envelope is advanced. A pair of juxtaposed rotary cutting gears is mounted in the slot and is driven to cut off a longitudinal strip of the advancing envelope. Although generally satisfactory for their intended purpose, such automatic letter openers are complex, relatively large, multi-part devices, which not only are costly and require a power source, but also, and perhaps more importantly, they leave behind the aforementioned envelope strips as waste. These strips accumulate and are very unsightly, particularly when a great deal of mail is being opened at one location.

The followings are some of the patents that have been granted in the area of letter openers. They are incorporated herein by reference in their entirety.

U.S. Pat. No. 4,069,585, issued to Kuster, on Jan. 24, 1978, teaches a letter opener having a grip-type handle, a cutting blade, and a guide slot.

U.S. Pat. No. 4,419,915, issued to Oussani, on Dec. 13, 1983, discloses a letter opener device, which is characterized in that the envelope, which is automatically fed, is slit through only a single face of the envelope. A further characterizing feature resides in a unique device for adjusting the cutting depth to achieve a precisely desired cutting effect.

U.S. Pat. No. 5,561,905, issued to Sherman, on Oct. 8, 1996, teaches a letter opener having a handle portion, a depending neck portion, oppositely extending tine portions carried by the neck portion, and two cutting blades with each mounted on one side of the neck portion.

U.S. Pat. No. 6,125,732, issued to Haug, on Oct. 3, 2000, describes a letter opener, which can open a conventional envelope without producing any waste. The letter opener comprises a round knife mounted by way of spring-generated pretension between two rails.

There is an important drawback associated with all the aforementioned prior arts; steel materials have been widely used for cutting blades. Since the cutting edge is subject, through repeated use, to high friction, so as to become dull and ultimately unusable, either the cutting blade needs frequent interchanges or the letter opener has to be discarded.

Therefore, it remains desirable to provide letter openers that can be used for opening letters with minimal efforts, that are convenient and safe to use, that are of durable construction, and that can be cheaply manufactured and inexpensively marketed.

### BRIEF SUMMARY OF THE INVENTION

Accordingly, the present invention is a letter opener. This letter opener comprises a main body having an open side, a covering piece for closing up the open side of the main body, a cutting blade rotatably installed inside the main body, a biasing member installed inside the main body for maintaining the cutting blade in position and for countering the rotation motion of the cutting blade when the cutting blade is in cutting mode. On the upper portion of the main body, there is a lip piece having a lower straight surface extending laterally. A through guide groove is formed in between the lip piece and the upper surface of the covering piece. The cutting blade, which is made of a ceramic material, extends upward across substantially the guide groove. When the letter opener is forced to slide along a marginal edge of a letter, the cutting blade operates to pierce through one layer of the letter and to cut a cutting line thereon, which is generally parallel to and offset by a slight spacing from the edge of the letter. The letter opener is convenient and safe to use and is of durable construction.

Accordingly, the followings are some of the objects, features, and advantages of the present invention:

It is an object of the present invention to provide a letter opener that overcomes the aforementioned drawbacks of manual and automatic letter openers.

It is another object of the present invention to provide a letter opener that opens an envelope without leaving strips of envelopes behind as waste.

It is a further more object of the present invention to provide a letter opener with a sharp cutting edge, which, nevertheless, does not represent a potential safety hazard.

It is a feature of the present invention that this letter opener includes a ceramic cutting blade, which is extremely sharp and highly friction resistant.

It is an advantage of the present invention that this letter opener can be conveniently used by both a right-handed and a left-handed person.

It is another advantage of the present invention that this letter opener is easy and safe to use, inexpensive to manufacture, and durable and reliable in operation.

Further more features and advantages of the present invention will be readily appreciated, as the same becomes better understood after reading the subsequent description when considered in connection with the accompanying drawings.

### BRIEF DESCRIPTION OF THE DRAWING

FIG. 1 illustrates a perspective view of an embodiment of the present invention, a letter opener 100, revealing additional details by lifting up of covering piece 104.

FIG. 2 illustrates a front view of blade 106 of FIG. 1.

### DETAILED DESCRIPTION OF THE INVENTION

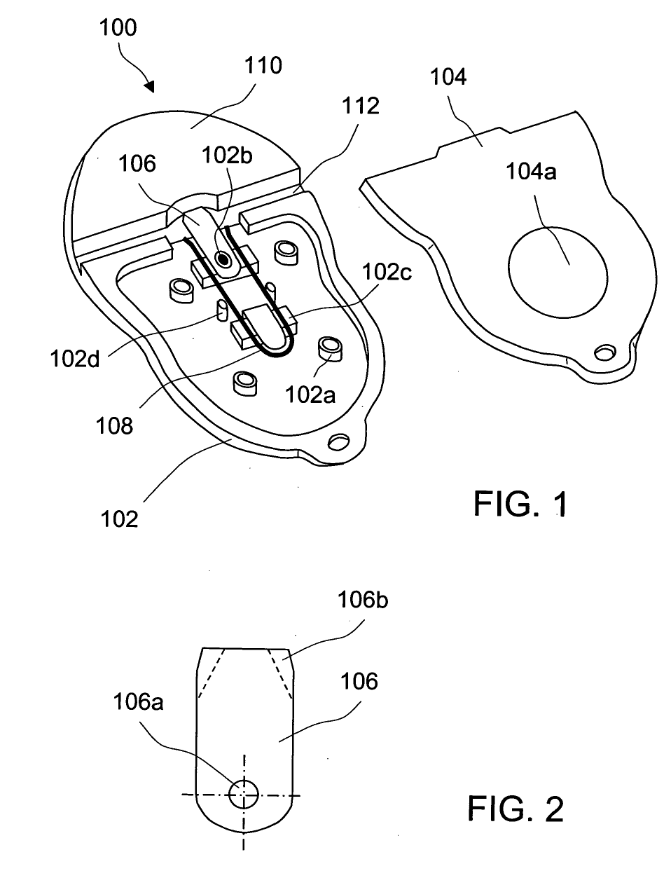

Reference is made to FIG. 1, which illustrates a perspective view of an embodiment of the present invention, a letter opener 100. Letter opener 100 comprises a main body 102, a covering piece 104, a cutting blade 106, and a spring member 108.

Main body 102, having an open side, is provided for holding covering piece 104, cutting blade 106, and spring member 108, together, and for grip handling by a hand. There is a lip piece 110 installed on the upper portion of main body 102. Lip piece 110 has a lower straight surface, which is disposed in a substantially horizontal orientation across the lateral dimension of main body 102. Lip piece 110 can be an integrated portion of main body 102, or a separated part removably installed onto main body 102. In the middle portion of the lower straight surface of lip piece 110, a small recess is provided, which is disposed at a location corresponding to extending cutting edges 106b of blade 106, as shown in FIG. 2, such that when a letter edge is passing against blade 106 therethrough, a small deformation of the envelope edge is allowed for avoiding both envelope layers being cut.

A plurality of hollow cylindrical protrusions, generally designated as 102a, is provided inside main body 102 for guiding and removably receiving some suitable protrusions from covering piece 104, such that covering piece 104 can be lockably installed onto main body 102.

Covering piece 104 is provided for covering on the open side of main body 102 for closing up the open side thereof. Covering piece 104 has an upper straight surface, which is disposed in a substantially horizontal orientation across the lateral dimension thereof. A through guide groove 112 is formed in between the lower surface of lip piece 110 and the upper surface of covering piece 104, when covering piece 104 is installed onto main body 102. Groove 112 is provided for guiding the edge of a letter against blade 106.

A recess 104a is provided on covering piece 104 for suitably receiving the thumb of a user for convenient grip handling. Recess 104a can be, alternatively, a clock, or any suitable decoration items. Some printed material can be applied on covering piece 104, or on the outer side surface of main body 102, as advertising messages.

Blade 106 is rotatably installed inside main body 102. There is provided a cylindrical protrusion 102b, installed inside main body 102, for slidably threading through a suitable aperture 106a, as more clearly shown in FIG.2, on the lower portion of blade 106. Blade 106 can pivotally rotate around protrusion 102b for a predetermined angle in each direction when blade 106 is in cutting mode, such that one of two cutting edges 106b, with one on each side of cutting blade 106, pierces through one layer of the letter. This double edged cutting blade design favors both right-handed users and left-handed users.

A plurality of protruding plateaus, generally designated as 102c, is provided inside main body 102 for raising blade 106 and spring member 108 to a predetermined height, relative to the inner flat surface of main body 102, such that the upper portion of blade 106 is elevated with a predetermined clearance with respect to the bottom of groove 112. This predetermined clearance determines the distance between the letter edge and the cutting line.

The selection of materials for blade 106 is important. Steel materials have been widely used. However, the performance of a steel sharp edge in resisting friction is not altogether satisfactory. Since the cutting edge is subject, through repeated use, to high friction, the sharp cutting edge becomes dull and ultimately the letter opener becomes unusable, thereby having to be discarded.

In this invention disclosure, a ceramic material is proposed for use with letter opener 100. As physical tests have shown, a ceramic cutting blade surpasses a steel one by a substantial margin.

Spring member 108 is provided for maintaining blade 106 in position and for countering the rotation motion of blade 106 in cutting mode. Spring member 108 is, preferably, of a U-shaped configuration. The lower portion of spring member 108 is engaged with plateaus 102c and held in position by a plurality of protrusions, generally designated as 102d. The two extending ends of spring member 108 abut each side of blade 106 for holding blade 106 in position. When blade 106 is in cutting mode, spring member 108, in countering the rotation motion of blade 106, applies a biasing force thereon, such that larger force is applied on blade 106 for opening a thicker letter.

In operation, a user first, inserts the edge of a letter to be opened inside guide groove 112; second, slides letter opener 100 along the edge of the letter. Letter opener 100 can be, alternatively, used, such that instead of sliding letter opener 100 along the edge of the letter, the user can slide the edge of the letter through guide groove 112.

Accordingly, readers will see that this letter opener of the present invention can be conveniently and safely used for opening letters by either a right-handed or a left-handed person without generating any envelope strips behind as waste. The cutting blade is made of a ceramic material, which is more durable than conventional steel blades.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

For examples, although this invention has been described in a form of a portable letter opener, it can have potential business use, such as use in offices. Therefore, this invention can alternatively be described as an office use device.

Thus it is understood that the present disclosure of the preferred forms can be changed in the details of construction and in the combination and arrangement of parts without departing from the spirit and the scope of the invention as hereinafter claimed.

1. A letter opener, said letter opener comprising:
a main body having an open side and a lip piece;
a covering piece for closing up said open side of said main body, wherein a through guide groove is formed in between said lip piece and said covering piece;
a cutting blade rotatably installed inside said main body, extending across substantially said through guide groove at a substantially right angle;
wherein said cutting blade is made of a ceramic material; and
spring means installed inside said main body for maintaining said cutting blade in position and for countering the rotation motion of said cutting blade when said cutting blade is in cutting mode.

2. A letter opener as defined in claim 1, wherein said cutting blade includes two cutting edges, with one on each side thereof, thereby allowing said letter opener to be conveniently used by both a right-handed person and a left-handed person.

3. A letter opener as defined in claim 1, wherein said spring means is a leaf spring having a U-shaped configuration with two extending legs abutting the two sides of said cutting blade for maintaining said cutting blade in position and for countering the rotation motion of said cutting blade when said cutting blade is in cutting mode.

4. (canceled)

5. (canceled)

6. (canceled)

7. (canceled)
